(19) United States
(12) Patent Application Publication
(10) Pub. No.: US 2026/0077290 A1
(43) Pub. Date: Mar. 19, 2026

(54) TECHNOLOGIES FOR IDENTIFYING DEBRIS ON FILTERS

(71) Applicant: BioNAV LLC, Springfield, MO (US)

(72) Inventor: Robert W. Freeman, II, Springfield, MO (US)

(21) Appl. No.: 19/402,028

(22) Filed: Nov. 26, 2025

Related U.S. Application Data
(63) Continuation of application No. PCT/US2024/031776, filed on May 30, 2024.
(60) Provisional application No. 63/469,856, filed on May 31, 2023.
(60) Provisional application No. 63/548,251, filed on Nov. 13, 2023.

(51) Int. Cl. B01D 46/00; B01D 35/143; B01D 46/42

(52) U.S. Cl. CPC B01D 46/0086; B01D 35/143; B01D 46/429

(57) ABSTRACT

This disclosure enables identification as to what type of debris is disposed on a filter (e.g., an air filter) and various computing actions dependent thereon. Such identification is technologically beneficial, because of its enablement of non-destructive and rapid testing without requiring expert knowledge or lab analysis, while also enabling detection of early signs of debris appearance (e.g., mold growth), thereby enabling timely intervention as needed.

### CROSS-REFERENCE TO RELATED PATENT APPLICATIONS

This patent application is a Continuation of International Application PCT/US2024/031776 filed 30 May 2024; which claims a benefit of priority to (1) a U.S. provisional patent application 63/548,251 filed 13 Nov. 2023, and (2) a U.S. provisional patent application 63/469,856 filed 31 May 2023; each of which is incorporated by reference herein in its entirety for all purposes.

### TECHNICAL FIELD

This disclosure relates to technologies for identifying debris on filters.

### BACKGROUND

Conventionally, an air filter of an air conditioner may be imaged to determine whether the air filter should be replaced. However, this manner of imaging does not enable any identification as to what type of debris is disposed on the air filter or any computing actions dependent thereon.

### SUMMARY

This disclosure enables identification as to what type of debris is disposed on a filter (e.g., an air filter) and various computing actions dependent thereon. Such identification is technologically beneficial, because of its enablement of non-destructive and rapid testing without requiring expert knowledge or lab analysis, while also enabling detection of early signs of debris appearance (e.g., mold growth), thereby enabling timely intervention as needed. This enablement may occur in various ways.

One of such ways may involve causing an input device (e.g., a camera) to capture an image of a set of debris (e.g., a growth of a mold) collected on a section of an input side of a filter installable or installed to filter a directed flow of a gas (e.g., air) where the set of debris is formed from the directed flow of the gas and the image shows a pattern depicting the set of debris; causing the input device to send the image to a network interface (e.g., a transmitter) such that the network interface sends the image to a server; and causing the server to (i) receive the image, (ii) detect the pattern (e.g., by a computer vision algorithm), (iii) identify a descriptor (e.g., a name) for the pattern, and (iv) take a computing action (e.g., instruct a display to present a message) based on the descriptor responsive to the image being captured.

Another one of such ways may involve causing an input device (e.g., a camera) to capture an image of a set of debris (e.g., a growth of a mold) collected on a section of an input side of a filter installable or installed to filter a directed flow of a gas (e.g., air) where the set of debris is formed from the directed flow of the gas and the image shows a pattern depicting the set of debris; and causing the input device to send the image to a processor such that the processor (i) detects the pattern (e.g., by a computer vision algorithm), (ii) identifies a descriptor (e.g., a name) for the pattern, and (iii) takes a computing action (e.g., instruct a display to present a message) based on the descriptor responsive to the image being captured, wherein the input device and the processor are collocated (e.g., within a locale).

Note that these ways can also be embodied as at least one of a system or an apparatus each configured to perform these actions, or a non-transitory medium (e.g., a memory) storing a set of instructions executable by a processing unit (e.g., a single core processor, a multicore processor, a Programmable Logic Controller (PLC), a graphics card, a graphics processing unit (GPU), a tensor core unit, a Tensor Processing Unit (TPU), an Application Specific Integrated Circuit (ASIC), a controller, an edge processor, a System-On-Chip (SOC), a hardware accelerator, a Neural Network (NN) accelerator, a Machine Learning (ML) accelerator) to perform these actions.

### DESCRIPTION OF DRAWINGS

FIG. 1 shows a diagram of an embodiment of a system for imaging a filter, where the system involves a server according to this disclosure.

FIG. 2 shows a flowchart of an embodiment of a method of using the system of FIG. 1 according to this disclosure.

FIG. 3 shows a diagram of an embodiment of a touchscreen of a smartphone or a tablet computer having a camera where the touchscreen displays a Graphical User Interface (GUI) presenting a questionnaire for completion by a user thereof according to this disclosure.

FIG. 4 shows a diagram of an embodiment of the GUI of FIG. 3 presenting a picture of a filter with a set of debris capturable or captured by the camera according to this disclosure.

FIG. 5 shows a diagram of an embodiment of the GUI of FIG. 3 presenting a set of possible messages generated based on the questionnaire completed by the user and a descriptor for the set of debris detected according to this disclosure.

FIG. 6 shows a diagram of an embodiment of an input device and a filter internal to a defined area according to this disclosure.

FIG. 7 shows a diagram of an embodiment of a filter external to a defined area containing an input device according to this disclosure.

FIG. 8 shows a diagram of an embodiment of a system for imaging a filter without involving a server according to this disclosure.

FIG. 9 shows a flowchart of an embodiment of a method of using the system of FIG. 8.

### DETAILED DESCRIPTION

As explained above, this disclosure enables identification as to what type of debris is disposed on a filter (e.g., an air filter) and various computing actions dependent thereon. Such identification is technologically beneficial, because of its enablement of non-destructive and rapid testing without requiring expert knowledge or lab analysis, while also enabling detection of early signs of debris appearance (e.g., mold growth), thereby enabling timely intervention as needed. This enablement may occur in various ways.

One of such ways may involve causing an input device (e.g., a camera) to capture an image of a set of debris (e.g., a growth of a mold) collected on a section of an input side of a filter installable or installed to filter a directed flow of a gas (e.g., air) where the set of debris is formed from the directed flow of the gas and the image shows a pattern depicting the set of debris; causing the input device to send the image to a network interface (e.g., a transmitter) such that the network interface sends the image to a server; and causing the server to (i) receive the image, (ii) detect the pattern (e.g., by a computer vision algorithm), (iii) identify a descriptor (e.g., a name) for the pattern, and (iv) take a computing action (e.g., instruct a display to present a message) based on the descriptor responsive to the image being captured.

Another one of such ways may involve causing an input device (e.g., a camera) to capture an image of a set of debris (e.g., a growth of a mold) collected on a section of an input side of a filter installable or installed to filter a directed flow of a gas (e.g., air) where the set of debris is formed from the directed flow of the gas and the image shows a pattern depicting the set of debris; and causing the input device to send the image to a processor such that the processor (i) detects the pattern (e.g., by a computer vision algorithm), (ii) identifies a descriptor (e.g., a name) for the pattern, and (iii) takes a computing action (e.g., instruct a display to present a message) based on the descriptor responsive to the image being captured, wherein the input device and the processor are collocated (e.g., within a locale).

Note that these ways can also be embodied as at least one of a system or an apparatus each configured to perform these actions, or a non-transitory medium (e.g., a memory) storing a set of instructions executable by a processing unit (e.g., a single core processor, a multicore processor, a PLC, a graphics card, a GPU, a tensor core unit, a Tensor Processing Unit TPU, an ASIC, a controller, an edge processor, a SOC, a hardware accelerator, a NN accelerator, a ML accelerator) to perform these actions.

This disclosure is now described more fully with reference to various figures that are referenced above, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled persons.

Various terminology used herein can imply direct or indirect, full or partial, temporary or permanent, action or inaction, individual or collective. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes,” “contains,” “has,” or “comprising,” “including,” “containing,” or “having” (or any tenses thereof) when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

As used herein, a term “about” or “substantially” refers to a +/−10% variation from a nominal value/term. Such variation is always included in any given value/term provided herein, whether or not such variation is specifically referred thereto.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled persons understand that typically there is no limit on a number of items or terms in any combination, unless otherwise contextually apparent.

Features or functionality described with respect to certain embodiments may be combined or sub-combined in or with various embodiments in any permutational or combinatorial manner. Different aspects or elements of embodiments, as disclosed herein, may be combined or sub-combined in a similar manner. A skilled person will understand that typically there is no limit on a number of items or terms in any combination, unless otherwise contextually apparent.

Some embodiments, whether individually or collectively, can be components of a larger system, where other procedures can take precedence over or otherwise modify their application. Additionally, a number of steps can be required before, after, or concurrently with embodiments, as disclosed herein. Note that any or all methods or processes, at least as disclosed herein, can be at least partially performed via at least one entity in any manner.

Some embodiments are described herein with reference to illustrations of idealized embodiments (and intermediate structures) of this disclosure. As such, variations from various illustrated shapes as a result, for example, of manufacturing techniques or tolerances, are to be expected. Thus, various embodiments should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary or monolithic, or be separately manufactured or connected, such as being an assembly or modules. Any or all elements, as disclosed herein, can be manufactured via any manufacturing processes, whether additive manufacturing, subtractive manufacturing, or any other types of manufacturing. For example, some manufacturing processes include Three Dimensional (3D) printing, laser cutting, Computer Numerical Control (CNC) routing, milling, pressing, stamping, vacuum forming, hydroforming, injection molding, lithography, fastening, adhering, nailing, stapling, threading, and so forth.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

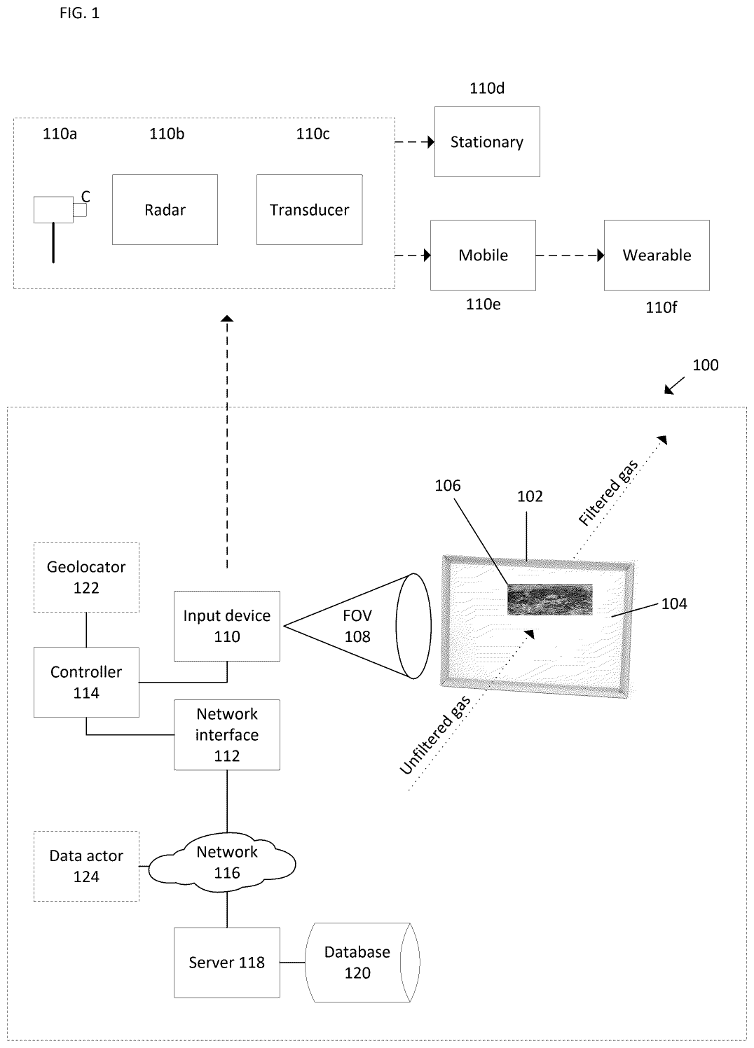

FIG. 1 shows a diagram of an embodiment of a system for imaging a filter, where the system involves a server according to this disclosure. In particular, there is a system 100 that includes a frame 102, a filter 104, a set of debris 106, a Field Of View (FOV) 108, an input device 110, a network interface 112, a controller 114, a network 116, a server 118, a database 120, a geolocator 122, and a data actor 124. The input device 110 may be embodied as at least one of a camera 110a, a radar 110b, or a transducer 110c, any of which may be hosted in or be a component of at least one of a stationary form factor 110d or a mobile form factor 110e. For example, at least one of the stationary form factor 110d or the mobile form factor 110e may include at least one of the input device 110, the network interface 112, or the controller 114. The mobile form factor 110e may be embodied as a wearable form factor 110f.

The frame 102 constitutes a paper material, although at least one of a wood material, a metal material, a plastic material, a fabric material, a fiberglass material, a carbon material, a foam material, or another suitable material is possible, whether water proof, water resistant, water repellent, washable, reusable, rinseable, washable, or neither. The frame 102 is rectangular in shape, but can be shaped differently (e.g., an open shape, a closed shape, a symmetrical shape, an asymmetrical shape, a square, a triangle, a circle, a pentagon, an octagon, an oval, a cylinder, a cube, a tear drop, a star). The frame 102 is sized to be handheld at least by a healthy adult aged 18-65, although this configuration is not required. The frame is stationary, but may be mobile during imaging, as disclosed herein. The frame 102 may be omitted.

The filter 104 is hosted by the frame 102 (e.g., by attachment) when the frame 102 is present. The filter 104 constitutes a woven, meshed, or pleated material (e.g., cotton, fiberglass, paper, plastic), although at least one of a wood material, a metal material, a plastic material, a fabric material, a paper material, a fiberglass material, a carbon material, a foam material, or another suitable material is possible, whether water proof, water resistant, water repellent, washable, reusable, rinseable, washable, or neither. The filter 104 is rectangular in shape, but can be shaped differently (e.g., an open shape, a closed shape, a symmetrical shape, an asymmetrical shape, a square, a triangle, a circle, a pentagon, an octagon, an oval, a cylinder, a cube, a tear drop, a star). When the frame 102 hosts the filter 104, the frame 102 can be handheld at least by a healthy adult aged 18-65, although this configuration is not required. The filter is stationary, but may be mobile during imaging, as disclosed herein. The filter 104 may be installed internally (e.g., within a nacelle, an engine bay, a body, an aerostructure, a chassis, an engine, a motor, a pump, a blower, a fan) within or externally on (e.g., an underside, a frame, flight control surface) a vehicle, whether manner or unmanned, whether aerial (e.g., a vertical or horizontal takeoff), land (e.g., car, bus, truck, tractor, tank), marine (e.g., ship, boat, submersible, submarine), or space (e.g., a satellite, a space station).

The filter 104 or the frame 102 hosting the filter 104 may be installed (e.g., inserted) into a path of a directed flow of a gas to remain in the path of the directed flow of the gas, as the path of the directed flow of the gas passes through the filter 104. As such, the filter 104 has an input side at which the directed flow of the gas occurs and an output side from which the directed flow of the gas, as filtered, exits. The path of the directed flow of the gas may be a rectilinear path, a curved path, a sinusoidal path, or another suitable path passing through the filter 104. The path is perpendicular to the input side of the filter 104, although acute or obtuse angling relative to the input side of the filter 104 is possible.

The directed flow of the gas may be controlled (e.g., on, off, gradual) by a blower, a fan, or another suitable source of the directed flow, whether by pushing (e.g., blowing) or pulling (e.g., suctioning) the gas, whether upstream or downstream the filter 104 or the frame 102 hosting the filter 104. For example, the directed flow of the gas may include propulsion, gravitational, inertia, temperature fluctuation (flux), or other suitable ways that gases may flow. The path of the directed flow of the gas may be within a tubular member (e.g., a tube, a conduit, a duct, a pipe, a hose) configured for receipt (e.g., permanent, temporary) of the filter 104 or the frame 102 hosting the filter 104. Longitudinally, the tubular member may have a rectilinear shape, a curved shape, a sinusoidal shape, or another suitable shape. Cross-sectionally, the tubular ember may have an open shape, a closed shape, a symmetrical shape, an asymmetrical shape, a square, a rectangle, a triangle, a circle, a pentagon, an octagon, an oval, a tear drop, a star, or another suitable shape. The tubular member may constitute metal or plastic, although other suitable materials (e.g., rubber) are possible, whether opaque, translucent, or transparent. The tubular member may be rigid (e.g., not able to be manually bent by a healthy adult aged between 18 and 65 without usage of any tools) or flexible (e.g., able to be manually bent by a healthy adult aged between 18 and 65 without usage of any tools). For example, the tubular member may be a component of or positioned within a Heating, Ventilation, and Air Conditioning (HVAC) system, an air handler, a window air conditioner, a mini-split air conditioning system, or another suitable system, whether residential or industrial, whether stationary (e.g., in a building) or mobile (e.g., in or on a vehicle). For example, the gas may be air, whether at ambient (e.g., room, outdoor) temperature, or conditioned, whether heated (e.g., at a temperature between about 70 degrees Fahrenheit and about 90 degrees Fahrenheit) or cooled (e.g., at a temperature between about 70 degrees Fahrenheit and about 90 degrees Fahrenheit). For example, the directed flow of the gas may occur in a duct conveying the air by a blower or a fan such that the air is conditioned (e.g., now) or can be conditioned (e.g., future), which may occur via a furnace, a condenser, a heat pump, or another suitable air conditioner. For example, the gas may be a single gas or a collection of gases, whether uncompressed or compressed. For example, the gas may be air. For example, the gas may be a noble gas. For example, the gas may be a natural gas or a synthetic gas. For example, the gas may be at least one of Argon (Ar), Methane (CH4), Carbon Dioxide (CO2), Acetylene (C2H2), Ethylene (C2H4), Propane (C3H8), Hydrogen (H2), para-Hydrogen (p-H2), Ammonia (NH3), Nitrogen (N2), Oxygen (O2), Helium (He), Xenon (Xe), Krypton (Kr), Neon (Ne), Carbon Monoxide (CO), N-Butane (C4H10), 1-Butene (C4H8), 2-cis-Butene (C4H8), 2-trans-Butene (C4H8), Cycloproane (C3H6), Deuterium (D2), Dimethylether ((CH3)20), Ethane (C2H6), Fluorine (F2), n-Heptane (C7H16), n-Hexane (C6H14), Hydrogen Sulfide (H2S), Isobutane (C4H10), Isobutene (C4H8), Isohexane (C6H14), Isopentane (C5H12), Menthanol (CH3OH), Neopentane (C5H12), Nitrous Oxide (N2O), Nitrogen Trifluoride (NF3), n-Pentane (C5H12), Hydrogen Chloride (HCl), Hydrogen Oxide (NO), Propene (C3H6), Propyne (C3H4), Sulfur Dioxide (SO2), Sulfur Hexafluoride (SF6), Toluene (C7H8), Trifluoroiodomethane (CF3I), Water Steam or Water Vapor (H2O), Bromochlorodifluoromethane (CBrClF2), Methyl Bromide (CH3Br), 1,1,2-Trichloro-1,2,2-Trifluorethane (C2F3Cl3), 1-Chloro-1,1-difluoroethane (C2H3ClF2), 1-Chlorodifluoromethane (CHClF2), 1-Chlorotrifluoromethane (CCl2F4), 1,2-Dichloro-1,1,2,2-tetrafluoroethane (C2Cl2F4), Dichlorodifluoromethene (CCl2F2), Dichlorofluoromethane (CCl12F), 2-Chloro-1,1,1-trifluroethane (C2H2ClF3), Chloropentafluoroethane (C2ClF5), Methyl Chloride (CH3Cl), Bromotrifluoromethane (CBrF3), Nitrogen Dioxide (NO2), Silane (SiH4), Trichloromonofluoromethane (CCl3F), Ozone (O3), or another suitable gas.

The input side of the filter 104 has the set of debris 106 disposed thereon, as captured during the directed flow of the gas, which may be in the tubular member. The set of debris 106 may be at least one of an organic matter, an inorganic matter, or any other suitable matter, which may include subatomic or elementary particles. For example, the set of debris 106 may include a particle (e.g., a growth, a spore, a contaminant, a fiber) of at least one of a flora member (e.g., a plant, a bush, a grass, a tree), a fauna member (e.g., a rodent, a bird, an animal), or an inorganic matter (e.g., a pollutant). For example, the particle of at least one of the flora member, the fauna member, or the inorganic matter is a rock, a paper, a dust, a lint, a fiberglass, a skin, a hair, an insect, an animal, a bird, a smoke, a tree, a weed, a grass, a pollen, a mold, a bacteria, a virus, a fungi, or another suitable substance.

The input device 110 has the FOV 108 directed at the input side of the filter 104 such that the set of debris 106 was, is, or will be within the FOV 108. As such, the input device 110 may be positioned or oriented, whether manually or automatically, at facing or opposing the input side of the filter 104 to be coaligned therewith or offset relative to the path of the directed flow of the gas such that the input side of the filter 104 is within the FOV 108 to be imaged, as disclosed herein. For example, the input device 110 may be oriented or capture perpendicular, acute, or obtuse to the input side of the filter 104 such that the set of debris 106 was, is, or will be within the FOV 108. The FOV 108 is conical, although this configuration is not required. For example, the FOV 108 may have a right cylindrical shape, an oblique cylindrical shape, or another suitable shape. The input device 110 is stationary, but may be mobile during imaging, as disclosed herein.

The input device 110 may be embodied as at least one of the camera 110a, the radar 110b, or the transducer 110c. As such, the input device 110 is powered by at least one of a mains electricity source (e.g., via a power cable, an electric cord, an extension cord) or an energy store (e.g., a battery, a capacitor). Optionally, when the input device 110 is embodied as the camera 110a, the input device 110 may include or be connected to a light source (e.g., a flash unit) to powerably (e.g., whether via the mains electricity source or the energy store) augment, enhance, or enable a capture of an image, as disclosed herein, although this form factor can be suitably adapted when the input device 110 is embodied at least one of the radar 110b or the transducer 110c. As such, the light source may be positioned or oriented, whether manually or automatically, at facing or opposing the input side of the filter 104 to be coaligned therewith or offset relative to the path of the directed flow of the gas such that the input side of the filter 104 is suitably illuminated to be imaged, as disclosed herein. For example, the light source may be oriented or illuminate perpendicular, acute, or obtuse to the input side of the filter 104 such that the set of debris 106 was, is, or will be suitably illuminated, as disclosed herein.

The camera 110a may be at least one of an infrared camera (e.g., for when the gas is heated or cooled), a monochrome camera (e.g., for low-light conditions), a telescope camera (e.g., for distal imaging), a thermal camera (e.g., for when the gas is heated or cooled), a dynamic camera (e.g., for movement to troubleshooting or surveillance), a static camera (e.g., for consistency of the FOV 108), a camera with a wide-angle lens (e.g., for the FOV 108 to be when due to space constraints), a webcam (e.g., for simplicity of installation to real-time monitor), a security or surveillance camera (e.g., for integration into a Video Management System), a smartwatch camera (e.g., for ease of imaging), a pen camera (e.g., for ease of imaging), a digiscope camera (e.g., for increased focus), a Three-Dimensional (3D) camera (e.g., for increased depth perception), an Ultra-Violet (UV) light camera (e.g., for increased biological perception), an area-scan camera (e.g., for improved resolution), a line-scan camera (e.g., for improved dynamic range), an electron camera (e.g., for higher signal to noise ratio), a water-resistant camera (e.g., for resistance to moisture), a water-proof camera (e.g., for proofing against water), a high-sensitivity or a low light camera (e.g., for imaging in dark conditions), a robotic camera (e.g., for heuristic automation), a holographic image sensor (e.g., for increased detection of the set of debris 106), a rapatronic camera (e.g., for increased dynamic range), a microscope camera (e.g., for increased detection of the set of debris 106), a strobe tachometer (e.g., visual “freeze” of motion to enable more accurate detection of the set of debris 106), or a laser sensor camera (e.g., for increased detection of the set of debris 106).

The input device 110 may be at least one of a time-of-flight radar (e.g., for stationary use cases) or a Doppler radar (e.g., for moving use cases).

The input device 110 may be a transducer, such as a primary transducer, a secondary transducer, or of another suitable type. For example, the transducer may be an ultrasound transducer (e.g., for use in foggy or steamy conditions).

The input device 110, such as the camera 110a, the radar 110b, or the transducer 110c, may be embodied in the stationary form factor 110d or the mobile form factor 110e. As such, the input device 110 may be mounted (e.g., supported, hoisted, suspended, attached, fastened, magnetized, mated, adhered) to or stabilized by a structure (e.g., as present in the camera 110a), whether a monolith or an assembly. For example, the structure may be a mount (e.g., L-shape, U-shape, V-shape, C-shape), whether a monolith or an assembly, where the filter 104 may be mounted in the frame 102 and the input device 110 may be mounted to the mount extending from at least one of the frame 102 or the filter 104. For example, the structure may be at least one of a tripod, a bracket (e.g., L-shape, U-shape, V-shape, C-shape), whether a monolith or an assembly, or a pedestal (e.g., a T-shape, an inverted T-shape), whether a monolith or an assembly, where the input device is a mounted on the at least one of the tripod, the bracket, or the pedestal. For example, the structure may be a gyrostabilizer, where the input device is stabilized by the gyrostabilizer. For example, the input device 110 may be mounted to a mount (e.g., L-shape, U-shape, V-shape, C-shape), whether a monolith or an assembly, for a diagnostic tool (e.g., a sensor, a gas sensor, a thermometer, a pressure sensor, a moisture sensor). For example, the input device 110 may be mounted to a mount (e.g., L-shape, U-shape, V-shape, C-shape), whether a monolith or an assembly, positioned inside a protective case (e.g., a handheld case, an attachable case). For example, the input device 110 may be mounted to a mount (e.g., L-shape, U-shape, V-shape, C-shape), whether a monolith or an assembly, extending from a display (e.g., a screen, a touchscreen). For example, the input device 110 may be mounted on a mount (e.g., L-shape, U-shape, V-shape, C-shape), whether a monolith or an assembly, positioned behind a glass (including glasslike or fiberglass material). For example, the input device 110 may be mounted on a mount (e.g., L-shape, U-shape, V-shape, C-shape) that is retractable (e.g., manually, automatically). For example, the input device 110 may be mounted on a mount (e.g., L-shape, U-shape, V-shape, C-shape), whether a monolith or an assembly, extending from a sensor (e.g., a temperature sensor, a pressure sensor, a moisture sensor) sensing at least one of the set of debris, the section, or the gas. For example, the input device may be mounted on a mount (e.g., L-shape, U-shape, V-shape, C-shape), whether a monolith or an assembly, extending from a light source (e.g., a lamp, a bulb, a flash unit). However, these configurations may be omitted. For example, the filter 104 may be mounted (e.g., fastened, adhered, mated, magnetized) in the frame 102, where the input device 110 extends from the frame 102. Likewise, the input device 110 may extend from the filter 104. Whether the structure is employed or not, whether with or without the filter 104, the input device 110 may be installed internally (e.g., within a nacelle, an engine bay, a body, an aerostructure, a chassis, an engine, at least one of a frame or a chassis supporting an engine, a motor, a pump, a blower, a fan) within or externally on (e.g., an underside, a frame, flight control surface) a vehicle, whether manner or unmanned, whether aerial (e.g., a vertical or horizontal takeoff), land (e.g., car, bus, truck, tractor, tank), marine (e.g., ship, boat, submersible, submarine), or space (e.g., a satellite, a space station). For example, the input device 110 and the filter 104 may be positioned within a submersible marine vehicle (e.g., to reduce noise). For example, the vehicle may be a robot, whether aerial, land, marine, or space, hosting the input device 110. For example, the input device 110 may be attached to an articulating arm, whether controlled manually or automatically.

The input device 110 (e.g., a camera) may be hosted by or be a component of the stationary form factor 110d. For example, the stationary form factor 110d may include the input device 110, the network interface 112, and the controller 114. For example, the stationary form factor 110d may be a wall, a floor, or a ceiling in a building, an appliance (e.g., a water boiler, a furnace, an air handler, a pump, a refrigerator), a furniture item (e.g., a chair, a table, a sofa, a shelf), a container (e.g., a pot, a pan, a planter), a desktop computer, a workstation computer, or another suitable stationary form factor.

The input device 110 (e.g., a camera) may be hosted by or be a component of the mobile form factor 110e. For example, the mobile form factor 110e may include the input device 110, the network interface 112, and the controller 114. For example, the mobile form factor 110e may be a laptop computer, a tablet computer, a mobile phone (e.g., a terrestrial network phone, a satellite phone), a dumb phone, a smart phone, a phablet computer, a wearable computer, or another suitable mobile computing form factor. For example, the input device 110 may be a camera of a smart phone. Regardless of form factor, note that the input device 110 (e.g., a camera) may be at least one of front-facing or back-facing.

The mobile form factor 110e may be the wearable form factor 110f. As such, the input device 110 may be hosted by or be a component of the wearable form factor 110f. For example, the wearable form factor 110d may be wearable by a person, an animal, a bird, a fish, a mannequin, a doll, a robot, or another suitable thing. For example, the wearable form factor 110d may include a headset computer, an eye frame computer, a garment computer, a hat computer, a watch, a smartwatch, or another suitable wearable form factor. For example, the input device 110 may be hosted (e.g., fastened, attached, mated) or be a component of a collar worn by an animal (e.g., a dog) or a robot.

The controller 114 may be a processing unit (e.g., a single core processor, a multicore processor, a PLC, a graphics card, a GPU, a tensor core unit, a TPU, an ASIC, a controller, an edge processor, a SOC, a hardware accelerator, a NN accelerator, a ML accelerator. The controller 114 controls the input device 110. As such, the controller 114 is powered by at least one of a mains electricity source (e.g., via a power cable, an electric cord, an extension cord) or an energy store (e.g., a battery, a capacitor), whether same or different from the input device 110.

The network interface 112 may be a hardware logic (e.g., a transmitter, a receiver, a transceiver, a chip, a networking card) programmed for a communication with a communication device (e.g., a hardware logic, a transmitter, a receiver, a transceiver, a chip, a networking card, a router, a base station, a cell site, a satellite). The communication may be line-of-sight (e.g., optical, acoustic) or not line-of-sight (e.g., radio, microwave). For example, the communication may be over at least one of a local area network (LAN), a wide area network (WAN), a personal area network (PAN), a mesh network, a satellite network, a neutrino network, or a cellular network. For example, the PAN may involve a Bluetooth protocol, a ZigBee protocol, or another suitable protocol. The controller 114 controls the network interface 112. As such, the network interface 112 is powered by at least one of a mains electricity source (e.g., via a power cable, an electric cord, an extension cord) or an energy store (e.g., a battery, a capacitor), whether same or different from at least one of the input device 110 or the controller 114.

The network 116 may be at least one of a LAN, a WAN, a PAN, a mesh network, a satellite network, a neutrino network, or a cellular network. The network interface 116 communicates with the network 116.

The server 118 (e.g., a single server, a set of servers, a server cloud, a server farm) may be a web server or an application server. The server 118 communicates with the network 116.

The database 120 is separate and distinct from the server 118, although this configuration is not required and the server 118 may host the database 120. The database 118 may local to the server 118 or remote from the server 118. The database 120 stores a set of records, where each such record stores a primary key, a descriptor (e.g., a name) of a debris item (e.g., a mold, a hair), and a set of images depicting the debris item 106 (e.g., of different angles, colors, shapes). For example, each of such records may contain a type identifier and a sub-type identifier for the debris item, if appropriate. For example, the descriptor may be “Mold” and the type identifier may be “Mucor.” Other information may be stored in such records as well, such as common and scientific names, descriptions, maps showing where the debris item has been observed, and times of year when the debris item is common or what causes the debris item to dispose on the filter 104. The database is relational, although this configuration is not required and the database can be configured differently (e.g., graph, in-memory).

The geolocator 122 may be a hardware logic (e.g., a chip) programmed for a communication with a geolocation network, whether terrestrial or satellite. For example, the geolocation network may be a Global Navigation Satellite System (e.g., a Global Positioning System (GPS), Galileo, BeiDou). The controller 114 controls the geolocator 122. As such, the geolocator 122 is powered by at least one of a mains electricity source (e.g., via a power cable, an electric cord, an extension cord) or an energy store (e.g., a battery, a capacitor), whether same or different from at least one of the input device 110, the controller 114, or the network interface 112. The geolocator 122 may be omitted.

The data actor 124 is a computing entity (e.g., a single server, a set of servers, a server cloud, a server farm, an Application Programming Interface (API)) that is programmed to receive a set of data from at least one of the network interface 112 or the server 118 over the network 116, process the set of data, and send the set of data to at least one of the network interface 112 or the server 118 over the network 116, as disclosed herein. The data actor 124 is separate and distinct from the server 118, although this configuration is not required and the data actor 124 and the server 118 may be one computing machine, whether physical or virtual. The data actor 124 may be omitted.

In one mode of operation, the system 100 enables the input device 110 to capture an image (e.g., a photo or a video in a JPEG format, a BMP format, a GIF format, a PNG format, an EPS format, a WebP format, an SVG format, a HEIF format, a XCF format, an AVIF format, a AVI format, an MPEG format, an MPEG4 format, 5GigE format, a 4K format, an 8K format) of the set of debris 106 collected on a section (e.g., central, lateral, top, bottom) of the input side of the filter 104 installable (e.g., handheld by a user after removal from or before insertion into the tubular member) or installed (e.g., in the tubular member) to filter the directed flow of the gas (e.g., air) where the set of debris 106 is formed from the directed flow of the gas and the image shows a pattern depicting the set of debris 106. The system 100 enables the input device 110 to send the image (or a copy thereof) to the network interface 112 (e.g., as instructed by or via the controller 114) such that the network interface 112 sends the image (or a copy thereof) to the server 118 (e.g., over the network 116). The system 100 enables the server 118 to (i) receive the image (or a copy thereof), (ii) detect the pattern in the image (e.g., based on querying the database 120), (iii) identify the descriptor (e.g., mold) for the pattern (e.g., based on querying the database 120), and (iv) take a computing action (e.g., serve the descriptor to be displayed) based on the descriptor responsive to the image being captured.

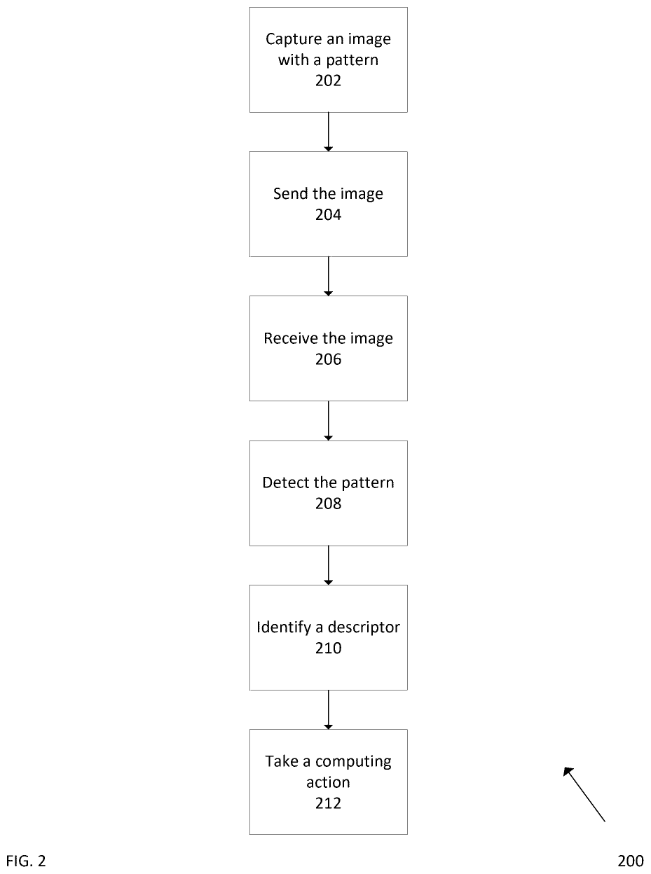

FIG. 2 shows a flowchart of an embodiment of a method of using the system of FIG. 1 according to this disclosure. In particular, a method 200 includes a set of blocks 202-212 performed by the system 100.

In block 202, the input device 110 captures an image (e.g., a photo or a video in a JPEG format, a BMP format, a GIF format, a PNG format, an EPS format, a WebP format, an SVG format, a HEIF format, a XCF format, an AVIF format, a AVI format, an MPEG format, an MPEG4 format, 5GigE format, a 4K format, an 8K format) of the set of debris 106 (e.g., mold) collected on a section (e.g., central, lateral, top, bottom) of an input side of the filter 104 installable (e.g., handheld by a user after removal from or before insertion into the tubular member) or installed (e.g., in the tubular member) to filter the directed flow of the gas (e.g., air) where the set of debris 106 is formed from the directed flow of the gas and the image shows a pattern depicting the set of debris 106. The image may be a photo or a video. The section of the input side of the filter 104 may be at least one of a partial section or a full section of the input side of the filter 104. The set of debris 106 is within the FOV 108. The image may be captured not during the directed flow of the gas, which may occur when the source of the directed flow the gas (e.g., a blower, a fan) is not running. Such modality of capture enables the server 118 to improve detection of the pattern, due to less image artifacts (e.g., blown dust) being present in the image. However, note that this modality is not required and the image may be captured during the directed flow of the gas, which may occur when the source of the directed flow the gas (e.g., a blower, a fan) is running. However, if there are image artifacts in the image, then those artifacts may be enables by the server 118 to be removed by appropriate computer vision algorithms, especially when accessing an ML model trained to detect those artifacts.

In block 204, the input device 110 sends the image (or a copy thereof) to the network interface 112 (e.g., as instructed by or via the controller 114) such that the network interface 112 sends the image to the server 118 (e.g., over the network 116). For example, the network interface 112 may send the image to the server 118 over at least one of a local area network (LAN), a wide area network (WAN), a personal area network (PAN), a mesh network, a satellite network, or a cellular network. Note that original or copies may be sent (e.g., for auditing, redundancy, history purposes).

In block 206, the server 118 receives the image (or a copy thereof) with the pattern.

In block 208, the server 118 detects the pattern in the image (or a copy thereof). The server 118 detects the pattern using various computer vision algorithms. For example, server 118 may detect the pattern based on considering at least one of image quality, shape, color, size, positioning, orientation, depth, lighting, a wavelength/frequency of signal (e.g., a measurement of an echo), a variation of a pixel (e.g., color, temperature, luminosity), or other image attributes of the pattern or related to or associated with the pattern (e.g., by spatial proximity). For example, the server 118 may detect the pattern by querying an API (e.g., Google Vision AI, ChatGPT 4-o, Facebook LLaMA, Google Gemini, Microsoft Copilot) with the image or based on the image. For example, the server 118 may detect the pattern by accessing an ML model (e.g., stored in the database 120) trained to detect a debris item. For example, the server 118 may detect the pattern by accessing a baseline image (e.g., stored in the database 120) depicting the section without the pattern and identifying a difference between the image from the input device 110 and the baseline image such that the pattern is the difference. For example, certain computer vision techniques (e.g., Convolutional NN (CNN), Recurrent NN (RNN), You Only Look Once (YOLO)) may be used by the server 118, which may involve querying the database 120, to detect mold (or other debris 106) on the filter 104. As such, there may be a Data Collection phase (e.g., build a dataset of images containing mold on the filters 104), a Data Annotation phase (e.g., annotation of debris regions in the dataset to provide ground truth labels for training a suitable model), a Model Training phase (e.g., training an object detection model (e.g., CNN, YOLO) on the annotated dataset to localize and classify debris regions on the filters 104), a Model Evaluation phase (e.g., evaluating the trained model's performance on a held-out test set using metrics like precision, recall, and mean Average Precision (mAP)), and a Deployment phase (e.g., deploying the trained model on edge devices or servers to detect mold in real-time from camera feeds or static images). For example, the server 118 may detect the pattern by employing a YOLO algorithm (e.g., v1, v2, v3, v4, v5, v6), which may be operative (e.g., trained) based on a dataset (e.g., sourced from at least one of a laboratory or a public data source), which may be stored on the database 120. For example, the dataset may include 10000 images from one data source and 10000 images from another data source, each image showing some pattern depicting various debris, as disclosed herein. However, note that other types of computer vision algorithms are possible (e.g., CNN, RNN, Faster R-CNN, RetinaNet).

In block 210, the server 118 identify the descriptor (e.g., mold) for the pattern, which may involve querying the database 120. Since there may be misidentifications or multiple identifications based on the pattern being detected, the server 118 may identify multiple descriptors and then generate suggestions, which may come with confidence scores, of matches that may be most likely based on visual patterns. Note that the server 118 may at least one of detect the pattern or identify the descriptor for the pattern by querying the database 120 storing the set of patterns and the set of pattern descriptors corresponding (e.g., one-to-one data correspondence, many-to-one data correspondence, one-to-many data correspondence, many-to-many data correspondence) to the set of patterns, as disclosed herein.

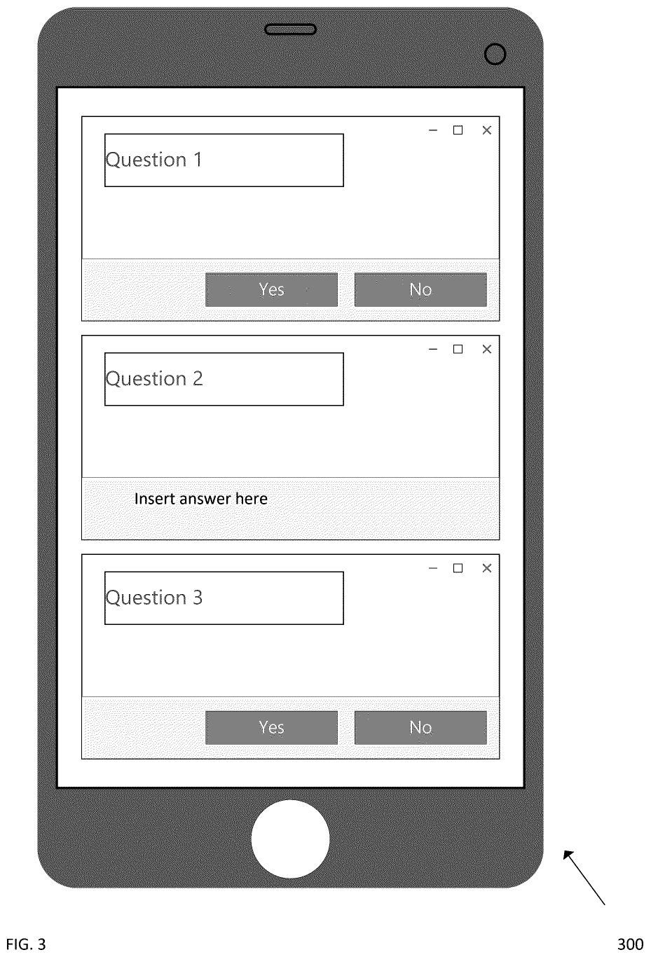

In block 212, the server 118 takes a computing action (e.g., serve the descriptor to be displayed) based on the descriptor responsive to the image being captured, which may be in real-time. The computing action may take various forms, any of which may or may not be customized based on a geolocation information, whether obtained from the geolocator 122 (e.g., via the controller 114) or as manually input (e.g., a computing terminal prompts the user enter a zip code or town name). For example, the computing action may be at least partially performed by the data actor 124 or not, or at least partially involve the data actor 124 or not. For example, the computing action may be causing the server 118 to send a message over the network 116 to a computing terminal (e.g., a desktop computer, a laptop computer, a smartphone, a terrestrial network phone, a satellite phone, a tablet computer, a wearable computer, a vehicle computer) such that the computing terminal outputs (e.g., via a screen or a speaker) a content (e.g., text, images, sounds) based on the descriptor, as described further in context of FIGS. 3-5. For example, the content may include the descriptor. For example, the content may indicate that the filter 104 should be at least one of changed or cleaned. For example, the content may include (e.g., be) a recommendation (e.g., text, imagery, sounds) for a user profile associated (e.g., on initial commissioning or during maintenance) with at least one of the input device 110 or the filter 104. For example, the recommendation may be compliant with relevant laws (e.g., federal laws, state laws, municipal laws) and regulations (e.g., government agency regulations, Federal Communication Commission (FCC) regulation, Federal Drug Administration (FDA) regulation), or may be audited for veracity prior to programming for such content to be presented. For example, the recommendation may include a boilerplate language (e.g., “Always consult with your doctor”). For example, the recommendation may be a medical health recommendation (e.g., leave this area, take your allergy medication). For example, the medical health recommendation may be personalized (e.g., leave this area since you indicated that you are allergic to pollen, take your Benadryl or Zyrtec medication). For example, the medical health recommendation may be based on the user profile containing (as prepopulated or default settings) a set of medical health attributes (e.g., a list of known allergies, a list of known pulmonary medical conditions), where the medical health recommendation is personalized based on the set of personal attributes. For example, the recommendation may include a Uniform Resource Locator (URL) to a web page (e.g., a personalized web portal, a knowledge web portal, an e-commerce web portal) containing a set of information (e.g., text, imagery, sounds) related to the descriptor. For example, the web page may describe a physical product (e.g., a filter, an air filter, a facial mask, a cleaning solution, a cleaning utensil, a brush, a medicine, a personalized medicine) related to the descriptor. For example, the web page may offer a good (e.g., a filter, an air filter, a facial mask, a cleaning solution, a cleaning utensil, a brush, a medicine, a personalized medicine) or a service (e.g., a cleaning service, a personalized cleaning service, a medical service, a personalized cleaning service) for sale, lease, or another suitable commercial activity, which may be based on the user profile (as pre-populated or default settings). For example, the controller 114 may obtain a geolocation information from the geolocator 122 (or the geolocation information may also be obtained from the user), where the geolocation information may be associated with at least one of the input device, the filter, or the computing terminal. As such, the recommendation may be customized to a weather forecast associated with at least one of the input device, the filter, or the computing terminal based on the geolocation information. For example, the recommendation may be customized to a set of environmental data (e.g., a pollen count, a UV index, an Air Quality Index (AQI), a Particular Matter Measurement (PMM)) collected based on a geolocation associated with at least one of the input device, the filter, or the computing terminal, whether the geolocation information is obtained via the controller 114 from the geolocator 122 (or the geolocation information may also be obtained from the user). For example, the computing action may be forming a set of data (e.g., text, images, sounds) by the server such that the set of data is based on or contains the descriptor and the set of data is sent to least one of a third party server (e.g., a personalized web portal, a knowledge web portal, an e-commerce web portal), a third party Point-Of-Sale (POS) machine (e.g., a cash register), or a third party (e.g., a relative, a vendor) computing terminal (e.g., a desktop computer, a laptop computer, a tablet computer, a mobile phone, a dumb phone, a smart phone, a phablet computer, a wearable computer, a vehicle computer). For example, the computing action may be presenting a report on a computing terminal (e.g., a desktop computer, a laptop computer, a tablet computer, a mobile phone, a dumb phone, a smart phone, a phablet computer, a wearable computer, a vehicle computer) based on or containing the descriptor. For example, the report may be a data file (e.g., a spreadsheet file, a word processing file, a web page) containing a reporting content, whether structured or unstructured, whether generic or personalized (e.g., based on user profile or default settings). For example, the reporting content may include diagrams, charts, figures, texts, images (e.g., photos, videos), sounds, or other suitable form of reporting content. For example, the report may be convertible to a standardized format (e.g., a Portable Document Format (PDF)).

Note that there may be a sensor (e.g., humidity, CO2, air quality, pressure) connected to the controller 114. The input device 110 and the sensor may be housed in a housing (e.g., a box, an enclosure, a case). The input device 110 may be housed in a first housing and the sensor may be housed in a second housing. The sensor may be attached (e.g., fastening, mating, adhering, magnetizing) to at least one of the frame 102, the filter 104, or the tubular member hosing the filter. The sensor may be attached (e.g., fastening, mating, adhering, magnetizing) to at least one of the input device 110, a mount (e.g., an L-shape, a T-shape, a C-shape, a U-shape, a J-shape) attached (e.g., fastening, mating, adhering, magnetizing) to, supporting, hoisting, suspending or otherwise holding the input device 110, or the frame 102. The sensor may be powered by at least one of a mains electricity source (e.g., via a power cable, an electric cord, an extension cord) or an energy store (e.g., a battery, a capacitor), whether same or different from at least one of the input device 110, the controller 114, the network interface 112, or the geolocator 122 (if present). As such, the sensor may sense at least one of the set of debris 106, the section of the input side of the filter 104, or the gas to form a set of sensing data. The sensor may send the set of sensing data to the network interface 112 (e.g., as instructed by or via the controller 114) such that the network interface 112 sends the set of sensing data to the server 118 (e.g., over the network 116). The server 118 may (i) receive the set of sensing data and (ii) analyze the set of sensing data such that the computing action is based on the set of sensing data as analyzed. For example, such analysis may enable the server 118 to better detect or cause better detection of the pattern. For example, such analysis may enable the server 118 to validate the pattern, because the set of sensing data is sourced from the sensor and the image is sourced from the input device 110. For example, such analysis may enable the server 118 to augment or supplement the descriptor or the computing action.

FIG. 3 shows a diagram of an embodiment of a touchscreen of a smartphone or a tablet computer having a camera where the touchscreen displays a Graphical User Interface (GUI) presenting a questionnaire for completion by a user thereof according to this disclosure. In particular, there is a GUI 300 presenting a questionnaire, which may be reflexive, with a set of questions presented as a set of prompts prompting a set of user inputs (e.g., binary, alphanumeric) relating a medical history of a person (whether user or someone else). The GUI 300 may be a software wizard. Although the camera is described here for brevity, this configuration is not required and any input device 110 may be used. Likewise, note that the smartphone or the tablet computer are described here for brevity, but any computing terminal may be used. For example, the computing terminal may host the input device 110, whether or not the computing terminal is collocated (e.g., in one locale, area, room, floor, building, vehicle) with at least one of the input device 110 or the filter 104.

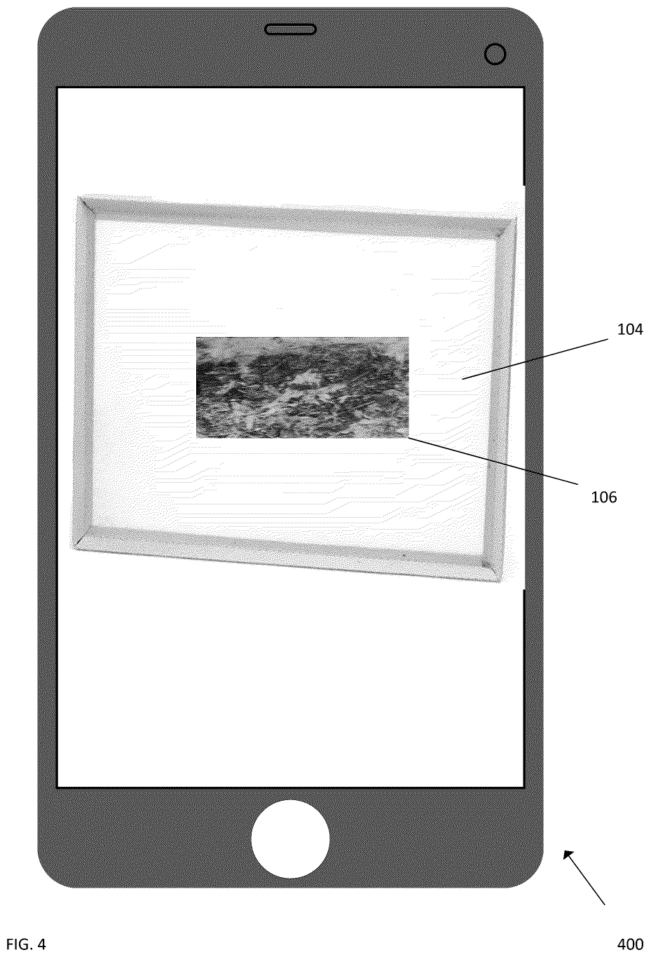

FIG. 4 shows a diagram of an embodiment of the GUI of FIG. 3 presenting a picture of a filter with a set of debris capturable or captured by the camera according to this disclosure. In particular, there is a GUI 400 presenting a live view as captured by the camera of the set of debris 106 disposed on the input side of the filter 104 when the camera is pointed at the input side of the filter 104, whether straight-on or at an angle. The GUI 400 may be a software wizard. The GUI 300 and the GUI 400 may be one GUI, which may be included in one software wizard. Note that if the smartphone or the tablet computer having the camera also has a flash unit, then the flash unit may be activated, whether automatically (e.g., based on an input from a light sensor hosted on the smartphone or the tablet computer) or manually (e.g., upon a user input). Although the camera is described here for brevity, this configuration is not required and any input device 110 may be used. Likewise, note that the smartphone or the tablet computer are described here for brevity, but any computing terminal may be used. For example, the computing terminal may host the input device 110, whether or not the computing terminal is collocated (e.g., in one locale, area, room, floor, building, vehicle) with at least one of the input device 110 or the filter 104.

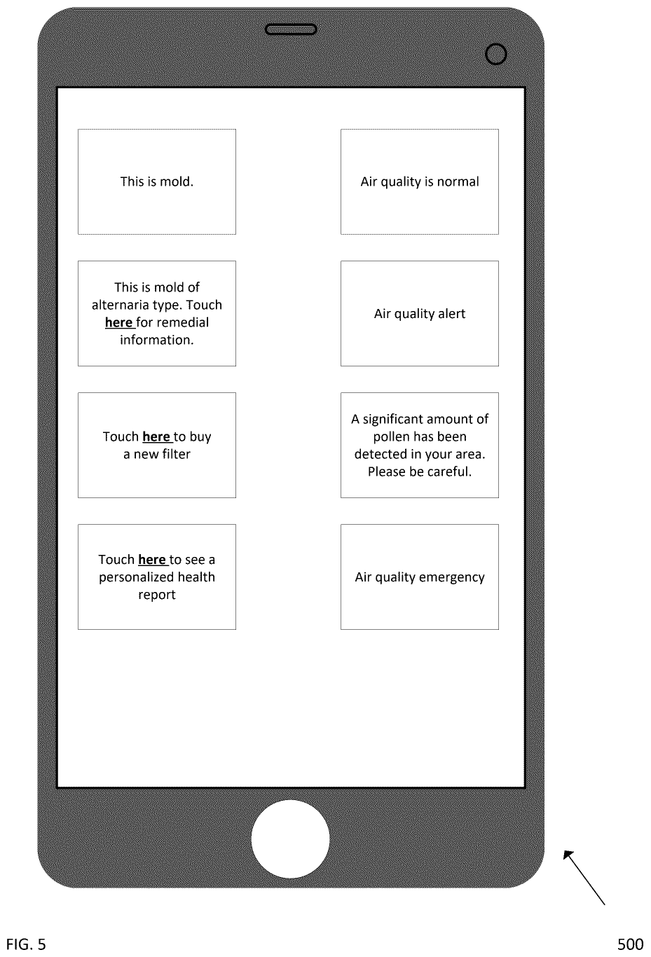

FIG. 5 shows a diagram of an embodiment of the GUI of FIG. 3 presenting a set of possible messages generated based on the questionnaire completed by the user and a descriptor for the set of debris detected according to this disclosure. In particular, there is a GUI 500 presenting a set of possible messages (e.g., text, hyperlinks, pictorial, video, diagrams) generated based on the questionnaire completed by the user and a descriptor for the set of debris 106 detected, as disclosed herein. The GUI 500 may be a software wizard. The GUI 500 and at least one of the GUI 300 or the GUI 400 may be one GUI, which may be included in one software wizard.

The report, as disclosed herein, may include any message shown in FIG. 5. For example, when the set of debris 106 is determined, as disclosed herein, not to satisfy a predetermined threshold (or vice versa), then there may be a default message, such as “air quality is normal.” However, when the set of debris 106 is determined, as disclosed herein, to satisfy a predetermined threshold (or vice versa), then there may be a single or a set of messages (e.g., with progressive or escalating severity) indicating that the set of debris 106 may correspond to or be associated with quality of air that is suboptimal, not desired, or an emergency (e.g., a forest fire, a volcano, a hurricane, a tornado, a pollutive event). These messages may be saved locally (e.g., on a computing terminal receiving those messages) or shared (e.g., by texting, email) with another computing terminal (e.g., a physician computing terminal, an emergency service computing terminal), whether local or remote. Some, many, most, or none of the set of possible messages may be shown. The GUI 500 may be a software wizard. The GUI 300, the GUI 400, and the GUI 500 may be one GUI, which may be included in one software wizard. Although the camera is described here for brevity, this configuration is not required and any input device 110, as disclosed herein, may be used. Likewise, note that the smartphone or the tablet computer are described here for brevity, but any computing terminal, as disclosed herein, may be used. For example, the computing terminal may host the input device 110, whether or not the computing terminal is collocated (e.g., in one locale, area, room, floor, building, vehicle) with at least one of the input device 110 or the filter 104.

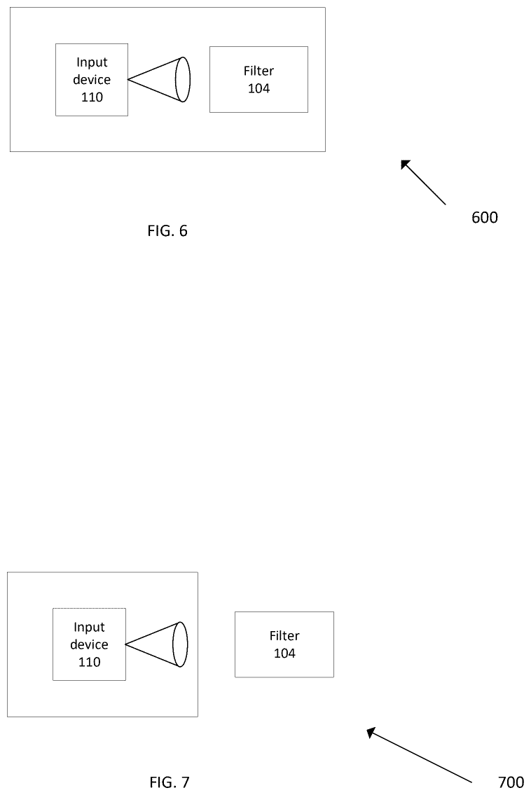

FIG. 6 shows a diagram of an embodiment of an input device and a filter internal to a defined area according to this disclosure. In particular, there is a defined area 600 (at least one of stationary or mobile) containing the input device 110 and the filter 104. As such, the directed flow of the gas to the filter 104 may be internal to at least one of a land vehicle, an aerial vehicle, a marine vehicle, or a spacecraft vehicle, each of which is an example of the defined area 600. Alternatively or additionally, the directed flow of the gas into the filter 104 may be internal to an object (e.g., a tubular member, a tube, a conduit, a duct, a gas handler, an air handler, a furnace, an air conditioner, an area, a room, a building, a tent, a warehouse, a factory, an underground facility, a basement), which is an example of the defined area 600. Note that at least one of the land vehicle, the aerial vehicle, the marine vehicle, or the spacecraft vehicle (e.g., the defined area 600) may contain the object (e.g., the defined area 600) or be the object (e.g., the defined area 600), or the object (e.g., the defined area 600) may contain or be at least one of the land vehicle, the aerial vehicle, the marine vehicle, or the spacecraft vehicle (e.g., the defined area 600).

FIG. 7 shows a diagram of an embodiment of a filter external to a defined area containing an input device according to this disclosure. In particular, there is the filter 104 and a defined area 700, which may be embodied as the defined area 600. The defined area 700 contains the input device 110. However, unlike FIG. 6, the filter 104 is external to the defined area 700. For example, the input device 110 may be in one defined area 700 and the filter 104 may be in another defined area 700.

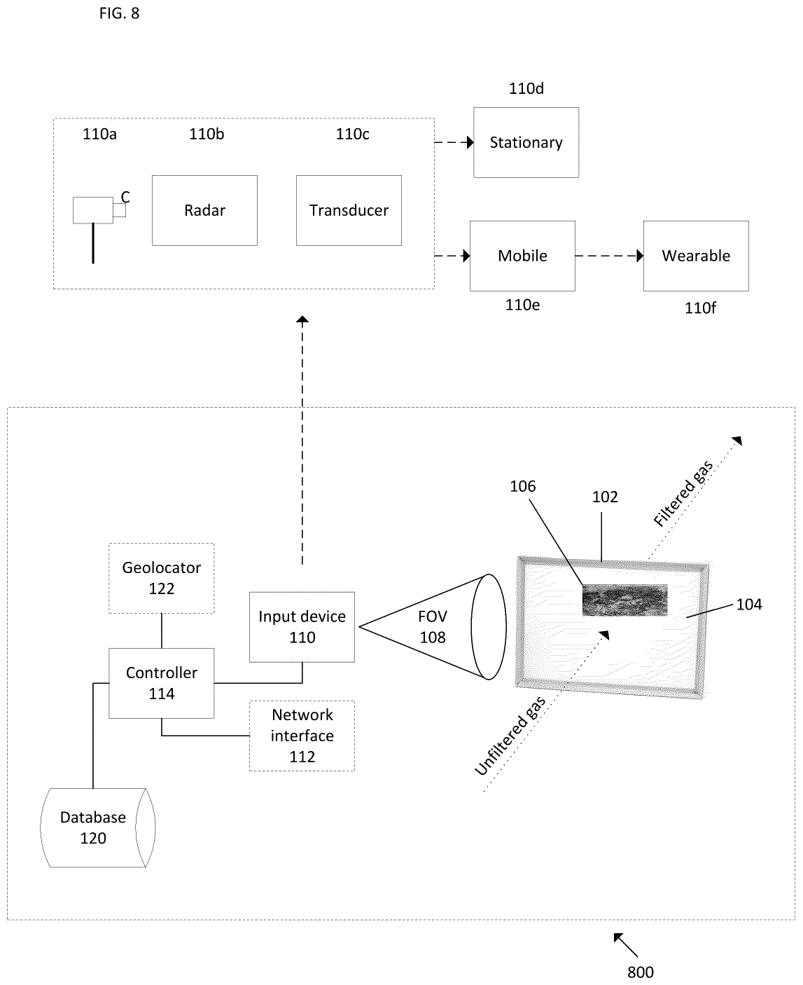

FIG. 8 shows a diagram of an embodiment of a system for imaging a filter without involving a server according to this disclosure. In particular, there is a system 800, which may be embodied as the system 100 shown in FIG. 1. However, unlike the system 100, the system 800 enables the pattern in the image to be detected by the controller 114 locally (e.g., an airplane mode) or at “edge,” without at least one of communicating with the network 116 or using the server 118, as described in context of FIG. 1. As such, in one mode of operation, the system 800 enables the input device 100 to capture the image (e.g., a photo or a video in a JPEG format, a BMP format, a GIF format, a PNG format, an EPS format, a WebP format, an SVG format, a HEIF format, a XCF format, an AVIF format, a AVI format, an MPEG format, an MPEG4 format, 5GigE format, a 4K format, an 8K format) of the set of debris 106 collected on the section (e.g., central, lateral, top, bottom) of the input side of the filter 104 installable (e.g., handheld by a user after removal from or before insertion into the tubular member) or installed (e.g., in the tubular member) to filter the directed flow of the gas (e.g., air) where the set of debris 106 is formed from the directed flow of the gas and the image shows the pattern depicting the set of debris. The system 800 enables the input device 100 to send the image (or a copy thereof) to a processor (e.g., a single core processor, a multicore processor, a PLC, a graphics card, a GPU, a tensor core unit, a TPU, an ASIC, a controller, an edge processor, a SOC, a hardware accelerator, a NN accelerator, a ML accelerator) such that the processor (i) detects the pattern (e.g., based on querying the database 120), (ii) identifies a descriptor (e.g., mold) for the pattern (e.g., based on querying the database 120), and (iii) takes a computing action (e.g., serve the descriptor to be displayed) based on the descriptor responsive to the image being captured. The processor may be the controller 114. The input device 110 and the processor may be collocated. For example, the input device 110 and the processor be hosted by or be components of a computing terminal (e.g., a desktop computer, a laptop computer, a tablet computer, a mobile phone, a dumb phone, a smart phone, a terrestrial network phone, a satellite phone, a phablet computer, a wearable computer, a vehicle computer). As such, the system 800 enables a local or an edge modality of detecting the pattern, which may be useful when the server 800 may be down or not accessible or the network 116 may be down or not accessible. Note that original or copies may be sent (e.g., for auditing, redundancy, history purposes).

A hybrid system may be possible, as enabled by the system 100 and the system 800. For example, the system 800 may enable the controller 114 to at least one of detect the pattern or identify the descriptor locally (e.g., an airplane mode) or at “edge”, without at least one of communicating with the network 116 or using the server 118, as disclosed herein, and then this respective detection or identification may be at least one of validated, verified, authenticated, augmented, or supplemented based on the controller 114 communicating with the server 118 via the network interface 112 over the network 116 when possible or appropriate. Additionally or alternatively, the database 120 in the system 800 may be periodically updated by the server 118 via the network interface 112 over the network 116, to maximize likelihood of detection of the pattern or identification of the descriptor, as needed, in the system 800.

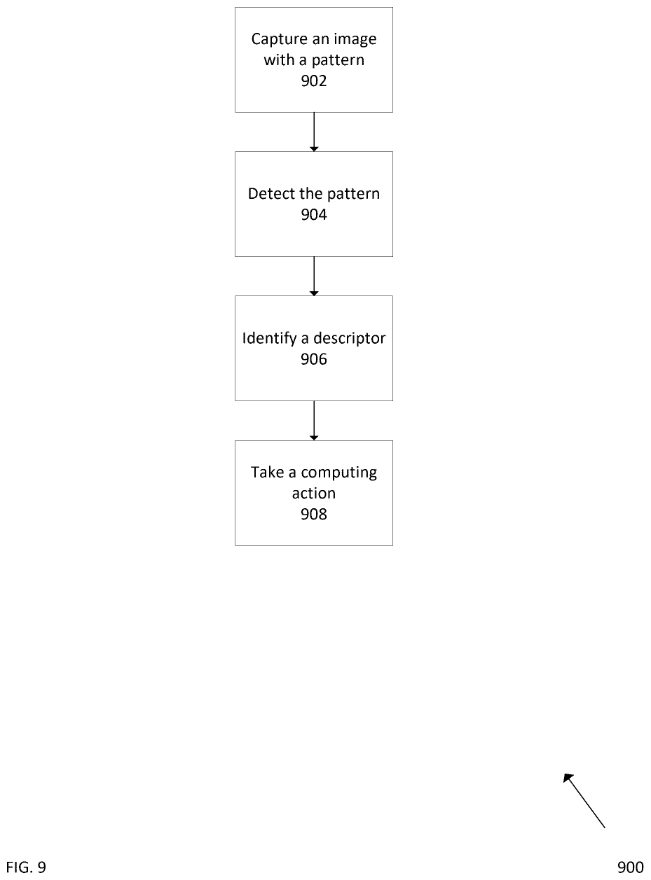

FIG. 9 shows a flowchart of an embodiment of a method of using the system of FIG. 8. In particular, a method 900 includes a set of blocks 902-908 performed by the system 800, whether alone or as the hybrid system, as disclosed herein. The method 900 is similar to the method 200, but adaptively differs based on how FIG. 8 differs from FIG. 1 (e.g., local detection or identification versus remote detection or identification), as disclosed herein.

In block 902, similar to the method 200, the input device 100 captures the image (e.g., a photo or a video in a JPEG format, a BMP format, a GIF format, a PNG format, an EPS format, a WebP format, an SVG format, a HEIF format, a XCF format, an AVIF format, a AVI format, an MPEG format, an MPEG4 format, 5GigE format, a 4K format, an 8K format) of the set of debris 106 collected on the section (e.g., central, lateral, top, bottom) of the input side of the filter 104 installable (e.g., handheld by a user after removal from or before insertion into the tubular member) or installed (e.g., in the tubular member) to filter the directed flow of the gas (e.g., air) where the set of debris 106 is formed from the directed flow of the gas and the image shows the pattern depicting the set of debris. The input device 100 to send the image (or a copy thereof) to a processor (e.g., a single core processor, a multicore processor, a PLC, a graphics card, a GPU, a tensor core unit, a TPU, an ASIC, a controller, an edge processor, a SOC, a hardware accelerator, a NN accelerator, a ML accelerator). Note that original or copies may be sent (e.g., for auditing, redundancy, history purposes).

In block 904, similar to the method 200, the processor detects the pattern (e.g., based on querying the database 120).

In block 906, similar to the method 200, the processor identifies a descriptor (e.g., mold) for the pattern (e.g., based on querying the database 120).

In block 908, similar to the method 200, the processor takes a computing action (e.g., serve the descriptor to be displayed) based on the descriptor responsive to the image being captured. The processor may be the controller 114. The input device 110 and the processor may be collocated. For example, the input device 110 and the processor be hosted by or be components of a computing terminal (e.g., a desktop computer, a laptop computer, a tablet computer, a mobile phone, a dumb phone, a smart phone, a phablet computer, a wearable computer, a vehicle computer). As such, the system 800 enables a local or an edge modality of detecting the pattern, which may be useful when the server 800 may be down or not accessible or the network 116 may be down or not accessible.

Although FIGS. 1-9 are described in context of filters (e.g., air filters), this configuration is not required and should not be viewed as limiting of this disclosure. As such, whether additionally or alternatively, this disclosure may be applicable to other objects, which are not filters, whether used in context of directed flows of gases or not. For example, these objects may include blades, foils, fan blades or foils, turbine blades or foils, vacuum blades or foils, propellers, various screens, magnetic (metallic) air (or another gas) flow filtration, strobe light image recognition synchronized to cameras (or other form factors of input devices 110), pans, siding, drywall, medical devices, or other suitable objects. Therefore, this disclosure further enables identification as to what type of debris is disposed on an object (e.g., a blade, a foil) and various computing actions dependent thereon. Such identification is technologically beneficial, because of its enablement of non-destructive and rapid testing without requiring expert knowledge or lab analysis, while also enabling detection of early signs of debris appearance (e.g., mold growth), thereby enabling timely intervention as needed. This enablement may occur in various ways.

One of such ways may involve causing an input device (e.g., a camera) to capture an image of a set of debris (e.g., a growth of a mold) collected on a section of a side of an object where the image shows a pattern depicting the set of debris; causing the input device to send the image to a network interface (e.g., a transmitter) such that the network interface sends the image to a server; and causing the server to (i) receive the image, (ii) detect the pattern (e.g., by a computer vision algorithm), (iii) identify a descriptor (e.g., a name) for the pattern, and (iv) take a computing action (e.g., instruct a display to present a message) based on the descriptor responsive to the image being captured. For example, this way may be enabled by the system 100, in view of descriptions for FIGS. 1-7.

Another one of such ways may involve causing an input device (e.g., a camera) to capture an image of a set of debris (e.g., a growth of a mold) collected on a section of a side of an object where the image shows a pattern depicting the set of debris; and causing the input device to send the image to a processor such that the processor (i) detects the pattern (e.g., by a computer vision algorithm), (ii) identifies a descriptor (e.g., a name) for the pattern, and (iii) takes a computing action (e.g., instruct a display to present a message) based on the descriptor responsive to the image being captured, wherein the input device and the processor are collocated (e.g., within a locale). For example, this way may be enabled by the system 800, in view of descriptions for FIGS. 8-9.

Note that these ways can also be embodied as at least one of a system or an apparatus each configured to perform these actions, or a non-transitory medium (e.g., a memory) storing a set of instructions executable by a processing unit (e.g., a single core processor, a multicore processor, a PLC, a graphics card, a GPU, a tensor core unit, a TPU, an ASIC, a controller, an edge processor, a SOC, a hardware accelerator, a NN accelerator, a ML accelerator) to perform these actions.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to be-come coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network, a neutrino network, an optical network (e.g., Li-Fi, fiberoptics), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of this disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required be-fore, after, and/or concurrently with example embodiments, as disclosed herein. Note that any and/or all methods and/or processes, at least as disclosed herein, can be at least partially performed via at least one entity or actor in any manner.

Although preferred embodiments have been depicted and described in detail herein, skilled persons know that various modifications, additions, substitutions and the like can be made without departing from spirit of this disclosure. As such, these are considered to be within the scope of the disclosure, as defined in the following claims.

What is claimed is:

1. A method, comprising:
causing an input device to capture an image of a set of debris collected on a section of an input side of a filter installable or installed to filter a directed flow of a gas where the set of debris is formed from the directed flow of the gas and the image shows a pattern depicting the set of debris;
causing the input device to send the image to a network interface such that the network interface sends the image to a server; and
causing the server to (i) receive the image, (ii) detect the pattern, (iii) identify a descriptor for the pattern, and (iv) take a computing action based on the descriptor responsive to the image being captured.

2. The method of claim 1, further comprising:
causing a sensor to sense at least one of the set of debris, the section, or the gas to form a set of sensing data;
causing the sensor to send the set of sensing data to the network interface such that the network interface sends the set of sensing data to the server; and
causing the server to (i) receive the set of sensing data and (ii) analyze the set of sensing data such that the computing action is based on the set of sensing data as analyzed.

3. The method of claim 2, wherein the input device and the sensor are housed in a housing.

4. The method of claim 1, wherein the input device is a mounted on at least one of a tripod, a bracket, or a pedestal.

5. The method of claim 1, wherein the input device is a camera on a smartphone.

6. The method of claim 1, wherein the input device is attached to an articulating arm.

7. The method of claim 1, wherein the input device is mounted on a mount positioned behind a glass.

8. The method of claim 1, wherein the input device is mounted on a mount that is retractable.

9. The method of claim 1, wherein the section is a partial section.

10. The method of claim 1, wherein the section is a full section forming the input side.

11. The method of claim 1, wherein the filter is installed to filter the directed flow of the gas, wherein the input device captures the image not during the directed flow of the gas.

12. The method of claim 1, wherein the image is a first image, wherein the server detects the pattern by accessing a second image depicting the section without the pattern and identifying a difference between the first image and the second image such that the pattern is the difference.

13. The method of claim 1, wherein the server at least one of detects the pattern or identifies the descriptor for the pattern by querying a database storing a set of patterns and a set of pattern descriptors corresponding to the set of patterns.

14. The method of claim 1, wherein the server detects the pattern based on at least one of a color, a wavelength or a frequency of a signal, a variation of a pixel, or a shape.

15. The method of claim 1, wherein the directed flow of the gas is internal to at least one of a land vehicle, an aerial vehicle, a marine vehicle, or a spacecraft vehicle.

16. The method of claim 1, wherein the computing action is forming a set of data by the server such that the set of data is based on or contains the descriptor and the set of data is sent to least one of a third party server, a third party Point-Of-Sale (POS) machine, or a third party computing terminal.

17. A method, comprising:
causing an input device to capture an image of a set of debris collected on a section of an input side of a filter installable or installed to filter a directed flow of a gas where the set of debris is formed from the directed flow of the gas and the image shows a pattern depicting the set of debris; and
causing the input device to send the image to a processor such that the processor (i) detects the pattern, (ii) identifies a descriptor for the pattern, and (iii) takes a computing action based on the descriptor responsive to the image being captured, wherein the input device and the processor are collocated.

18. The method of claim 17, wherein the processor at least one of detects the pattern or identifies the descriptor for the pattern by querying a database storing a set of patterns and a set of pattern descriptors corresponding to the set of patterns, wherein the database is collocated with at least one of the input device or the processor.

19. The method of claim 17, wherein the computing action is causing the processor to instruct an output device to output a content based on the descriptor, wherein the output device is collocated with at least one of the input device or the processor.

20. The method of claim 17, wherein the processor detects the pattern based on at least one of a color, a wavelength or a frequency of a signal, a variation of a pixel, or a shape.
